(19) United States
(12) Patent Application Publication
(10) Pub. No.: US 2013/0160843 A1
(43) Pub. Date: Jun. 27, 2013

(54) ULTRA-LOW TEMPERATURE SINTERING OF DYE-SENSITESED SOLAR CELLS

(71) Applicants: Peter Holliman, Conwy Gwynedd (GB); Arthur Connell, Bethesda Gwynedd (GB)

(72) Inventors: Peter Holliman, Conwy Gwynedd (GB); Arthur Connell, Bethesda Gwynedd (GB)

(73) Assignee: Bangor University, Bangor Gwynedd (GB)

(21) Appl. No.: 13/697,241

(22) PCT Filed: May 10, 2011
(86) PCT No.: PCT/EP2011/057558

§ 371 Date: Jan. 16, 2013

(30) Foreign Application Priority Data
May 11, 2010 (GB) 1007870.7

(51) Int. Cl. H01G 9/20

(52) U.S. Cl. CPC H01G 9/2022
USPC 136/256; 438/98

(57) ABSTRACT

This invention relates to the field of dye-sensitised solar cells and discloses a method for reducing the temperature necessary for sintering the metal oxide paste coating the electrode.

### BACKGROUND OF THE INVENTION

1. Field of the Invention

This invention relates to the field of dye-sensitised solar cells and to a method for reducing the temperature necessary for sintering the metal oxide paste coating the electrode.

2. Description of the Related Art

Solar cells are traditionally prepared using solid state semiconductors. Cells are prepared by juxtaposing two doped crystals, one with a slightly negative charge, thus having additional free electrons (n-type semiconductor) and the other with a slightly positive charge, thus lacking free electrons (p-type semiconductor). When these two doped crystals are put into contact with each other, extra electrons from the n-type semiconductor flow through the n-p junction to reduce the lack of electrons in the p-type semiconductor. At the p-n junction, charge carriers are depleted on one side and accumulated on the other side thereby producing a potential barrier. When photons produced by sunlight strike the p-type semiconductor, they induce transfer of electrons bound in the low energy levels to the conduction band where they are free to move. A load is placed across the cell in order to transfer electrons, through an external circuit, from the p-type to the n-type semiconductor. The electrons then move spontaneously to the p-type material, back to the low energy level they had been extracted from by solar energy. This motion creates an electrical current.

Typical solar cell crystals are prepared from silicon because photons having frequencies in the visible light range have enough energy to take electrons across the band-gap between the low energy levels and the conduction band. One of the major drawbacks of these solar cells is that the most energetic photons in the violet or ultra-violet frequencies have more energy than necessary to move electrons across the band-gap, resulting in considerable waste of energy that is merely transformed into heat. Another important drawback is that the p-type layer must be sufficiently thick in order to have a chance to capture a photon, with the consequence that the freshly extracted electrons also have a chance to recombine with the created holes before reaching the p-n junction. The maximum reported efficiencies of the silicon-type solar cells are thus of 20 to 25% or lower for solar cell modules, due to losses in combining individual cells together.

Another important problem of the silicon-type solar cell is the cost in terms of monetary price and also in terms of embodied energy, that is the energy required to manufacture the devices. Dye-sensitised solar cells (DSSC) have been developed in 1991 by O'Regan and Gratzel (O'Regan B. and Grätzel M., in Nature, 1991, 353, 737-740). They are produced using low cost material and do not require complex equipment for their manufacture. They separate the two functions provided by silicon: the bulk of the semiconductor is used for charge transport and the photoelectrons originate from a separate photosensitive dye. The cells are sandwich structures as represented in FIG. 1 and are typically prepared by the steps of:
a) providing a transparent plate (1) typically prepared from glass;
b) coating this plate with a transparent conducting oxide (TCO) (2), preferably with doped tin oxide;
c) applying a paste of metal oxide (3), generally titanium dioxide, to the coated glass plate on the TCO side;
d) heating the plate to a temperature of about 450° C. to 600° C. for a period of time of at least one hour;
e) soaking the coated plate of step d) in a dye solution for a period of time of about 24 hours in order to covalently bind the dye to the surface of the titanium dioxide (4);
f) providing another TCO coated transparent plate further coated with platinum (5);
g) sealing the two glass plates and introducing an electrolyte solution (6) between said plates in order to encase the dyed metal oxide and electrolyte between the two conducting plates and to prevent the electrolyte from leaking.

In these cells, photons strike the dye moving it to an excited state capable of injecting electrons into the conducting band of the titanium dioxide from where they diffuse to the anode. The electrons lost from the dye/TiO₂ system are replaced by oxidising the iodide into triiodide at the counter electrode, whose reaction is sufficiently fast to enable the photochemical cycle to continue.

The DSSC generate a maximum voltage comparable to that of the silicon solar cells, of the order of 0.8 V. An important advantage of the DSSC, as compared to the silicon solar cells, is that they inject electrons in the titanium dioxide conduction band without creating electron vacancies nearby, thereby preventing quick electron/hole recombinations. They are therefore able to function in low light conditions where the electron/hole recombination becomes the dominant mechanism in the silicon solar cells. The present DSSC are however not very efficient in the lower part of the visible light frequency range in the red and infrared region, because these photons do not have enough energy to cross the titanium dioxide band-gap or to excite most traditional ruthenium bipyridyl dyes.

A major disadvantage of the DSSC resides in the high temperature necessary for sintering the metal oxide paste. Another drawback of the dye-sensitised solar cells lies in the long time necessary to dye the titanium dioxide nanoparticles: it takes between 12 and 24 hours to dye the layer of titanium dioxide necessary for solar cell applications. Another major difficulty with the DSSC is the electrolyte solution: the cells must be carefully sealed in order to prevent liquid electrolyte leakage and therefore cell deterioration.

In an attempt to decrease the sintering temperature, WO 031065394 discloses a method using poly(butyl-titanate) as sintering agent in a colloidal paste comprising metal oxide nanoparticles, said paste being then coated to the surface of the counter-electrode

There is thus a need to prepare robust solar cells that can be prepared rapidly at reduced cost.

### SUMMARY OF THE INVENTION

It is an objective of the present invention to reduce the temperature necessary for sintering the metal oxide paste coating the electrode of dye-sensitised solar cells.

It is also an objective of the present invention to prepare the metal oxide paste as an aqueous solution.

It is another objective of the present invention to ensure good adhesion both within the metal oxide film and between the metal oxide film and the substrate.

It is a further objective of the present invention to use a chemical sintering agent to prepare the metal oxide paste.

It is yet another objective of the present invention to provide a metal oxide film having high porosity.

In accordance with the present invention, the foregoing aims are realised as defined in the independent claims. Preferred embodiments are defined in the dependent claims.

### BRIEF DESCRIPTION OF THE DRAWINGS

FIG. 1 is a schematic representation of a dye-sensitised solar cell.

### DESCRIPTION OF THE PREFERRED EMBODIMENTS

Accordingly, the present invention discloses a method for ultra-low temperature sintering of metal oxide paste coating the electrode of dye-sensitised solar cells.

The method comprises the steps of:

a) providing an electrode prepared from an electro-conducting substrate;
b) optionally pre-treating the electro-conducting substrate of step a) to ensure good adhesion of the metal oxide film.
c) preparing a colloid comprising at least one metal oxide, a solvent, optionally an adhesion agent and optionally one or more binder;
d) adding from zero wt % up to 20 wt %, based on the weight of the metal oxide, of a thermal sintering agent to the colloid of step c);
e) adding from more than zero, preferably at least 1 vol %, more preferably at least 2 vol % and up to 10 vol %, preferably up to 5 vol %, and more preferably up to 3 vol %, based on the volume of water of a chemical sintering agent to the colloid of step c) or step d);
f) optionally adding a titania precursor to the colloid of step e) preferably selected from TiCl₄ or titanium isopropoxide in water;
g) optionally pre-treating the electrode of step a) with a metal oxide precursor, preferably selected from TiCl₄ or titanium isopropoxide;
h) applying the composition of step f) to electrode a) or b) or g);
i) heating the coated electrode to a temperature of at most 150° C. for sintering the metal oxide followed by cooling to a temperature of about 100° C.;
j) optionally post-treating the metal oxide film with a metal oxide precursor selected from TiCl₄ or titanium isopropoxide solution and re-sintering to a temperature of at most 150° C., followed by cooling to a temperature of about 100° C.;
k) retrieving the electrode coated with sintered metal oxide.

Sintering is an important step in the preparation of dye-sensitised solar cell devices. It ensures that the metal oxide particles adhere to each other thereby efficiently carrying current and also that they adhere strongly to the electrode substrate. Sintering also ensures complete removal of any organic binder and/or solvent present in the metal oxide colloid paste thereby increasing the porosity of the metal oxide film. It also helps to prepare the metal oxide surface for successful dye sensitization. Metal oxide colloids are also used to apply metal oxide to the electro-conducting substrate by screen-printing or doctor blading techniques to ensure that the film does not collapse after application. In the present invention it is preferably applied by etch deposition.

The metal oxide colloid is a paste of nanoparticles preferably prepared from a colloidal solution of metal oxide. The electronic and physical contact between the particles is produced by sintering. Said sintering was typically carried out in the prior art by thermal treatment at a temperature of 450° C. to 600° C. for a period of time of at least 30 minutes. In the present invention, an optional pre-treatment step is included to improve adhesion of the metal oxide film to the electro-conducting substrate. Sintering is then carried out at a temperature of at most 150° C., preferably of at most 120° C. The thermal treatment is followed by cooling, down to a temperature between room temperature and a temperature of about 120° C. The metal oxide film is then ready for dyeing unless the 120° C. sintering step is optionally followed by a post-sintering treatment step whereby the metal oxide film is exposed to a solution of TiCl₄ followed by re-sintering at a temperature of at most 150° C., preferably of at most 120° C. followed by cooling as in the previous treatment. Such additional treatment is preferably present because it can improve the efficiency of the solar cell. The size of the particles and pores making up the film is determined by the metal oxide particles' size and by the choice of binder, if present, used in the aqueous colloidal solution and also the ratio of oxide:binder:water. The internal surface of the film is an important parameter, also determined by the particles' size and by the film's thickness. The best combination of parameters depends upon the nature of the components used in the mixture and therefore upon the viscosity of the paste. Ideally, the viscosity is selected to allow the metal oxide film to be tipped without running but is sufficient to be doctor bladed or screen printed. The pore size must be large enough to allow easy diffusion and percolation of the electrolyte in the DSSC device. The metal oxide particle sizes preferably range from 10 nm 30 nm, preferably from 12 nm 20 nm. The film thickness ranges from 5 μm to 20 μm, preferably from 7 μm to 15 μm. For example, in order to arrive at a final selected metal oxide thickness of about 10 μm, a paste layer of about 50 μm is spread on the electrode through either one or two applications. It is then allowed to dry and is reduced in thickness. This is followed by a heat treatment that further reduces the thickness to 10 μm, half of which is titanium dioxide and the other half is porosity. The amount of titanium dioxide in the composition is thus of 20 vol % based on the total volume of the paste.

Water is mixed with the metal oxide paste in order to form an aqueous colloidal dispersion. It is added in an amount of at least 300 wt %, preferably at least 350 wt %, up to 500 wt %, most preferably about 400 wt %, based on the weight of the metal oxide. The metal oxide paste is very viscous and cannot be stirred easily.

The optional binder mixed with the metal oxide paste can be selected from long chain polymers such as ethyl cellulose or polyethylene glycol or polyvinyl alcohol.

The water and optional binder are added to the metal oxide and the mixture is stirred for several hours, homogenised for several minutes and sonicated for several minutes at room temperature to ensure homogeneous mixing of all components.

Ultra-low temperature sintering is achieved by first adding a binder to the colloid solution of metal oxide and water. The binder is a long chain polymer selected for example from polyethylene glycol, polyvinyl alcohol or ethyl cellulose, preferably it is polyethylene glycol. The binder serves several purposes. It stabilises and thickens the colloid solution thereby preventing it from collapsing and running when it is spread on the electrode. It also helps to provide porosity to the metal oxide paste, thereby favouring and improving percolation of the dye through the metal oxide paste. It is optional but is preferably added in an amount of at least 20 wt %, preferably at least 30 wt %, up to 40 wt %, most preferably about 32 wt %, based on the weight of the metal oxide. Most typically titanium dioxide particles are used to form the metal oxide films because this material gives the highest recorded efficiencies in DSSC devices. In prior art conditions, titanium dioxide required sintering temperatures of 450° C. to 600° C. to successfully remove the binder material and sinter the metal oxide particles together. Other metal oxides can be used such as ZnO but the resulting DSC devices give lower DSC device efficiencies.

In addition to the sintering process, the thermal treatment serves the double purpose of evaporating the solvent and combusting the binder which, being a long polymer chain, is not volatile. It is essential that both water and binder are removed during sintering to produce a “clean” metal oxide surface for dyeing. If carbonaceous material remains within the metal oxide film, insufficient dye is adsorbed by the metal oxide film and poor dye sensitized solar cell device efficiency results.

The thermal sintering agent mixed with the metal oxide is another oxide selected from manganese oxide, vanadium oxide, barium oxide, niobium oxide or cerium oxide. It is optional but is preferably added in an amount of more than zero, preferably at least 1 wt %, more preferably at least 5 wt % and up to 20 wt %, preferably up to 15 wt %, and more preferably up to 10 wt %, based on the weight of the metal oxide. The thermal catalyst operates during the heating taking place during the sintering cycle. This heating is carried out by exposing the film to energy such as radiant heating. Before heating, the unsintered film contains water, and optionally a polymeric binder which need to be removed along with non-combustible and non-volatile components such as metal oxide semiconductor, thermal catalyst, sintering catalyst and adhesion agent. With a typical heating rate of 20° C. min⁻¹, in the absence of thermal catalyst, water is lost through evaporation between room temperature and a temperature of approximately 120° C. The optional polymeric binder is lost through combustion between temperatures of 200° C. and 450° C. The addition of the optional thermal catalyst does not affect the loss of water by evaporation but rather enables the binder combustion to occur at a lower temperature by acting as an oxidation catalyst thereby lowering the activation energy of the combustion reaction, providing a reaction surface on which combustion can occur and acting as a localised oxygen source for combustion to occur.

The chemical sintering agent chemical is selected from a fluoride-based material such as but not limited to an aqueous solution of hexafluorotitanic acid, or hexafluorozirconic acid or hydrogen fluoride, or ammonium fluoride or ammonium bifluoride or a mixture thereof.

The chemical sintering agent is added in an amount of more than zero, preferably at least 1 vol %, more preferably at least 2 vol % and up to 10 vol %, preferably up to 5 vol %, and more preferably up to 3 vol %, based on the volume of water.

The chemical sintering agent has the technical effect of dissolving the surface of metal oxide particles and allowing them to stick together thereafter in an etch deposition process.

An optional titania precursor can be used. It is an aqueous suspension of titanium oxide particles which can be prepared from a titanium oxide precursor added to nitric acid. The titanium oxide precursor can be selected from a soluble titanium species such as for example titanium isopropoxide or titanium tetrachloride. It is added to nitric acid in an amount of the order of 17% relative to the amount of water in a method known in the prior art.

The optional titania precursor can be used in place of water to be mixed with the metal oxide paste in order to form an aqueous colloidal dispersion. It is added in an amount of at least 300 wt %, preferably at least 350 wt %, up to 500 wt %, most preferably in an amount of about 400 wt %, based on the weight of the metal oxide. The metal oxide paste is very viscous and cannot be stirred easily.

The optional titania precursor has the technical effect of providing an additional source of titanium oxide which can help to sinter the existing titanium dioxide particles together to improve photo-electrode performance.

The concentration of metal oxide within the colloid is controlled and optionally increased with respect to conventional methods. This is useful because higher levels of titania in the colloid allow thicker titania photoelectrodes to be deposited on the conducting electrode substrate. Thicker photoelectrodes are useful because they can give rise to more efficient DSSC devices through higher dye uptake and hence increased photon capture.

In an alternative process, a precursor of the optional thermal catalyst is added to a precursor of the metal oxide semiconductor during its synthesis by the sol gel method, followed by hydrothermal treatment to enhance the crystallinity of the oxide material. Precursors for the thermal catalysts can include for example manganese acetate or manganese acetylacetonate for manganese oxide, niobium ethoxide for niobium oxide, vanadyl acetylacetonate or vanadyl oxytriiospropoxide for vanadium oxide, barium acetate or barium isopropoxide for barium oxide or ammonium cerium nitrate or cerium isopropoxide for cerium oxide. For the metal oxide semiconductor, the precursor is typically titanium isopropoxide for titanium dioxide and, the precursor is typically zinc nitrate or zinc acetate for zinc oxide. The resultant mixed-metal oxide is then prepared into a colloidal paste and applied to the substrate and sintered as described above. This sintering step can be followed by treatment with TiCl₄ solution and re-sintering as described above.

In yet another process, the optional thermal catalyst is added to the metal oxide semiconductor by a process of wet impregnation. Precursor agents for wet impregnation of the thermal catalysts can include for example manganese acetate or manganese acetylacetonate for manganese oxide, niobium ethoxide for niobium oxide, vanadyl acetylacetonate or vanadyl oxytriiospropoxide for vanadium oxide, barium acetate or barium isopropoxide for barium oxide or ammonium cerium nitrate or cerium isopropoxide for cerium oxide. The resultant metal oxide is then prepared into a colloidal paste and applied to the substrate and sintered as described above. This sintering step can be followed by treatment with TiCl₄ solution and re-sintering as described above.

The adhesion agent can include calcium oxide or calcium hydroxide or polyvinyl alcohol and/or a flocculating agent such as polyacrylamide or polyacrylic acid. The adhesion agent is added to aid the adhesion of titania particles to each other within the film but also to aid adhesion of the titania nanoparticles to the electro-conducting substrate. The adhesion agent is preferably added to the paste. If present, the sintering temperature can be further reduced without reducing the adhesion of metal oxide particles to one another and to the substrate.

The sintering time is between 30 minutes to 1 hour. Increasing the sintering time can further decrease the sintering temperature or vice versa. The sintering temperature is of at most 150° C., preferably of at most 130° C. and more preferably of at most 120° C.

Other than the reduction of sintering temperature, the binder, adhesion agent, thermal catalyst, chemical sintering agent and optional titania precursor have an effect on the final coated electrode. It ensures the production of a film of metal oxide nanoparticles which is of uniform thickness, said thickness being determined by the paste contents and the thickness of the spacer used during application. It also provides homogeneous coverage over the substrate surface and a porosity of up to 50% of the film volume.

Dye-sensitised solar cells are then prepared according to any method known in the art. Preferably they are prepared according to a fast-dyeing method described in co-pending patent application PCT/EP2010/051135. According to that method, dye-sensitised solar cells are prepared by the steps of:
a) providing a first electrode prepared from an electro-conducting substrate;
b) preparing a colloid comprising:
   A) at least one semiconducting metal oxide
   B) an optional adhesion agent such as calcium oxide or calcium hydroxide or polyvinyl alcohol and/or a flocculating agent such as polyacrylamide or polyacrylic acid and a solvent, and
   C) an optional binder
c) adding from 0 up to 20 wt %, based on the weight of the metal oxide, of an optional thermal sintering agent either (i) as a separate material or (ii) by doping the semiconductor metal oxide by sol gel processing or (iii) by doping the semiconductor metal oxide by wet impregnation along with more than 0 up to 10 vol %, based on the volume of solvent, of a chemical sintering agent and an optional titania precursor in place of water to make the colloid of step b);
d) optionally pre-treating the electro-conducting substrate of step a) with a metal oxide precursor such as TiCl₄ or titanium isopropoxide to aid adhesion
e) applying the composition of step c) to the conducting side of first electrode a);
f) heating the coated electrode to a temperature of at most 150° C. for sintering the metal oxide(s);
g) optionally post-treating the metal oxide film with a metal oxide precursor such as TiCl₄ or titanium isopropoxide and sintering again to a temperature of at most 150° C. to improve the open circuit voltage V_{oc} thereby improving cell efficiency.
h) providing a second electrode, the counter-electrode, prepared from a transparent substrate coated with a transparent conducting oxide and additionally coated with platinum or carbon;
i) optionally pre-dyeing the first electrode coated with metal oxide of step e) with a solution comprising one or more dyes in order to covalently bind said dye(s) to the surface of the metal oxide;
j) piercing at least two perforations in the first and/or second electrodes and sealing said electrodes together with glue or with a thermoplastic polymer;
k) pumping one or more solution(s) comprising the same one or more dyes as those of the pre-dyeing step along with cosorbents through the holes in the electrodes in order to covalently bind said dye(s) to the surface of the metal oxide wherein dyeing is carried out between the sealed electrodes at a temperature of from 10° C. to 70° C.;
l) injecting an electrolyte through the holes in the electrodes either simultaneously with the dye(s) or not more than 10 minutes after the dye;
m) sealing the holes in the electrodes with glue or with a thermoplastic polymer;
n) providing an external connection between the two electrodes for electron transport.

In industrial applications, the DSSC can be prepared using a roll-to-roll process.

Solar panels can then be prepared by connecting individual solar cells prepared according to the present invention in the same or different colours.

### EXAMPLES

### Comparative Examples

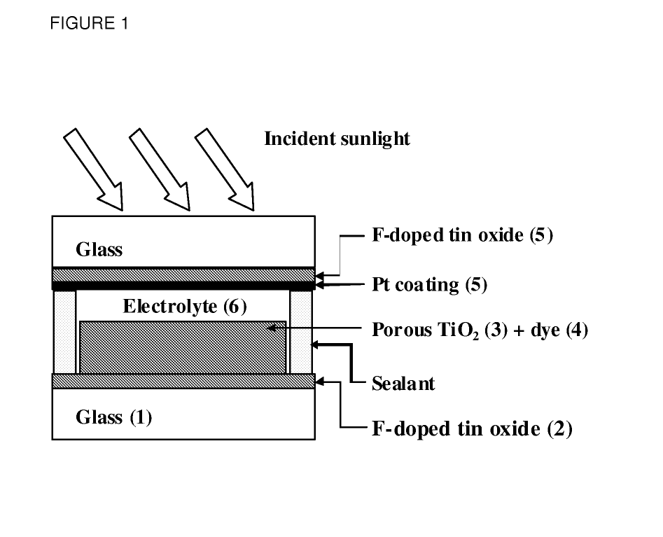

Sandwich-type DSC cells devices were prepared following the structure described in FIG. 1. The working photoelectrode was prepared on fluorine tin oxide (FTO)-coated glass with resistance of 15 Ω/cm² by doctor blading a colloidal paste of titania using a spacer of 1 layer of Scotch® tape to create a thin film of titania having a thickness of approximately 7 μm with a working area of 1.0 cm².

Colloidal pastes were prepared by mixing metal oxide (1.6 g of titania) with terpineol (350 wt %, based on the weight of the metal oxide), ethanol (75 wt % based on the weight of the metal oxide) and water (35 wt % based on the weight of the metal oxide) and ethyl cellulose binder (32 wt % based on the weight of metal oxide). The mixture was heated to a temperature of about 60° C. and stirred for 48 hours, cooled to room temperature and homogenised at 8000 rpm for 25 minutes followed by sonication for 30 minutes. Ethanol was removed by heating at 45-50° C. for 48 h with stirring.

Once the colloid was applied to the FTO substrate, it was allowed to dry prior to sintering. Comparative samples were heated to a temperature of 450° C. for 30 minutes and cooled to about 100° C. Prior to dyeing, some samples were also dipped in a 50 mM TiCl₄:THF solution at a temperature of 70° C. for 30 minutes and, after rinsing with water and ethanol films, these were sintered again at 450° C. for 30 minutes and cooled to about 100° C.

The resultant metal oxide films were dipped into ethanolic dye solution containing the di-ammonium salt of cis-bis(4,4′-dicarboxy-2,2′-bipyridine)dithiocyanato ruthenium(II), commonly known as N719 (1 mM) for time periods of 16-18 hours. After dyeing, a thermoplastic polymer gasket (Surlyn® from Du Pont) was placed around the photoelectrode and a second transparent-conducting glass coated electrode with a platinum layer, the counter electrode, was placed on top and the electrodes sealed together at a temperature of 120° C. A commercial liquid electrolyte containing iodine/tri-iodide in nitrile solvent (Dyesol Ltd, Australia) was added through a hole in the counter electrode which was then sealed using thermoplastic polymer Surlyn® from Du Pont). Table 1 displays typical efficiency data and fill factors along with the open circuit voltage or voltage at zero current V_{oc} and the short circuit current or current at zero voltage J_{sc} for comparative cells (1.0 cm²).

TABLE 1

| | Sintering | | | | | |
|---|---|---|---|---|---|---|
| | temperature | TiCl₄ post- | | J_{sc} | Fill | Efficiency |
| Metal oxide | (° C.) | treatment | V_{oc}/V | (mA cm⁻²) | factor (%) | (%) |
| Titania | 450 | Yes | 0.75 | 11.3 | 0.56 | 4.73 |
| | 290 | Yes | 0.58 | 1.0 | 0.68 | 0.40 |
| | 120 | N/A* | 0 | 0 | 0 | 0 |

*It is impossible to make a DSSC device from photoelectrodes sintered at 120° C. because the titania will not adhere to the electrode substrate.

### Examples According to the Invention

Sandwich-type DSC cells devices were prepared following the structure described in FIG. 1. The working photoelectrode was prepared on fluorine tin oxide-coated glass with resistance of 15 Ω/cm² by doctor blading a colloidal paste of titania using a spacer of 1 layer of Scotch® tape to create a thin film of titania having a thickness of approximately 7 μm, with a working area of approximately 1.0 cm².

Colloidal pastes were prepared by mixing a combination of metal oxide titania (1 g) and water (400 wt % based on the mass of metal oxide). An aqueous solution of hexafluorotitanic acid (HTA) was added to this suspension (3 vol % based on the volume of water) and the mixture stirred. An optional titania precursor was added in place of water (400 wt % based on the mass of metal oxide) to make up the colloidal paste.

Once the colloid was applied to the FTO substrate, it was allowed to dry prior to sintering. Comparative samples were heated either to 500° C. or to 300° C. or to 120° C. for 30 minutes and cooled to about 100° C. ready for dyeing. Prior to dyeing, some samples were also dipped in a 50 mM TiCl₄:THF solution at 70° C. for 30 minutes and, after rinsing with water and ethanol films, these were sintered again at either 500° C. or 300° C. or to 120° C. for 30 minutes and cooled to about 100° C. ready for dyeing.

The resultant metal oxide films were dipped into ethanolic dye solution containing the di-ammonium salt of cis-bis(4,4′-dicarboxy-2,2′-bipyridine)dithiocyanato ruthenium(II), commonly known as N719 (1 mM) for time periods of 16-18 hours. After dyeing, a thermoplastic polymer gasket (Surlyn® from Du Pont) was placed around the photoelectrode and a second transparent-conducting glass coated electrode with a platinum layer, the counter electrode, was placed on top and the electrodes sealed together at a temperature of 120° C. A commercial liquid electrolyte containing iodine/tri-iodide in nitrile solvent (Dyesol Ltd, Australia) was added through a hole in the counter electrode which was then sealed using thermoplastic polymer (Surlyn® from Du Pont). The data are displayed in Table II, they exhibit typical efficiency data and fill factors comparable to those of solar cells of approximately 1.0 cm² prepared using conventional methods.

### Example 1

The working photoelectrode was prepared on fluorine tin oxide-coated glass with resistance of 15 Ωcm⁻² by doctor blading a colloidal paste of titania in water also containing the chemical sintering agent as described above. The paste was heated to 500° C. and then dipped in 50 mM TiCl₄:THF solution at 70° C. for 30 minutes, rinsed with water and ethanol and sintered again at 500° C. for 30 minutes and cooled to about 100° C. prior to dyeing. Cell area=0.95 cm², V_{oc}=0.76 V, J_{sc}=9.87 mA cm⁻², Fill factor=0.60, Efficiency=4.7%.

### Example 2

The working photoelectrode was prepared on fluorine tin oxide-coated glass with resistance of 15 Ωcm⁻² by doctor blading a colloidal paste of titania in water also containing the chemical sintering agent as described above. The paste was heated to 300° C. and then dipped in 50 mM TiCl₄:THF solution at 70° C. for 30 minutes, rinsed with water and ethanol and sintered again at 300° C. for 30 minutes and cooled to about 100° C. prior to dyeing.

### Example 3

The working photoelectrode was prepared on fluorine tin oxide-coated glass with resistance of 15 Ωcm⁻² by doctor blading a colloidal paste of titania in water also containing the chemical sintering agent as described above. The paste was heated to 120° C. and then dipped in 50 mM TiCl₄:THF solution at 70° C. for 30 minutes, rinsed with water and ethanol and sintered again at 120° C. for 30 minutes and cooled to about 100° C. prior to dyeing.

TABLE II

| | Sintering T | Cell area | Voc | Jsc | Fill | Efficiency |
|---|---|---|---|---|---|---|
| Ex | ° C. | cm² | V | mAcm⁻² | factor % | % |
| 1 | 500 | 0.95 | 0.76 | 9.87 | 0.60 | 4.7 |
| 2 | 300 | 0.85 | 0.76 | 8.32 | 0.60 | 4.5 |
| 3 | 120 | 0.85 | 0.77 | 7.22 | 0.69 | 4.5 |

### Example 4

The working photoelectrode (1 cm²) was prepared on indium tin oxide-coated polyethylene terephthalate (PET) with resistance of 15 Ωcm⁻² by doctor blading a colloidal paste of titania in water also containing the varying amounts of a chemical sintering agent as described above. The paste was heated to 120° C. and then dipped in 50 mM TiCl₄:THF solution at 70° C. for 30 minutes, rinsed with water and ethanol and sintered again at 120° C. for 30 minutes and cooled to about 100° C. prior to dyeing. Device data are shown in Table III.

TABLE III

| | HTA | | | J_{sc} | |
|---|---|---|---|---|---|
| Ex | μl | η % | Fill factor % | mA cm⁻² | V_{oc}/V |
| 1 | 5 | 2.6 | 0.69 | 4.7 | 0.83 |
| 2 | 10 | 2.9 | 0.66 | 5.3 | 0.84 |
| 3 | 15 | 4.2 | 0.71 | 7.2 | 0.83 |
| 4 | 20 | 3.2 | 0.68 | 5.5 | 0.86 |

### Example 5

The working photoelectrode was prepared on fluorine tin oxide-coated glass with resistance of 15 Ωcm⁻² by doctor blading a colloidal paste of titania in water also containing the chemical sintering agent as described above. The paste was heated to 120° C. and then dipped in 50 mM TiCl₄:THF solution at 70° C. for 30 minutes, rinsed with water and ethanol and sintered again at 120° C. for 30 minutes and cooled to about 100° C. prior to dyeing. Devices were dyed using ultra-fast co-sensitisation using the ruthenium dye commonly known as N719 and the squaraine dye commonly known as SQ1 by pumping the solutions through pre-sealed devices prior to adding the electrolyte as described above. Data show fill factor=0.66, J_{sc}=11.0 mA cm⁻², V_{oc}=0.83 V and efficiency q=6.1%.

### Example 6

The working photoelectrode (1 cm²) was prepared on titanium metal sheet by doctor blading a colloidal paste of titania in water also containing the varying amounts of a chemical sintering agent as described above. The paste was heated to 120° C. and then dipped in 50 mM TiCl₄:THF solution at 70° C. for 30 minutes, rinsed with water and ethanol and sintered again at 120° C. for 30 minutes and cooled to about 100° C. prior to dyeing. Device data are shown in Table IV.

TABLE IV

| | HTA | | | J_{sc} | |
|---|---|---|---|---|---|
| Ex | μl | η % | Fill factor % | mA cm⁻² | V_{oc}/V |
| 1 | 30 | 2.2 | 0.66 | 4.9 | 0.70 |
| 2 | 50 | 3.0 | 0.66 | 6.9 | 0.76 |
| 3 | 75 | 2.8 | 0.64 | 7.1 | 0.61 |

1-12. (canceled)

13. A method for ultra-low temperature sintering of a metal oxide paste coating an electrode of a dye-sensitised solar cell, said method comprising the steps of:
a) providing an electrode prepared from an electro-conducting substrate;
b) preparing a colloid comprising at least one metal oxide and a solvent, wherein the solvent is present in an amount ranging from more than zero wt % to 500 wt % based on the weight of the metal oxide;
c) adding from more than zero vol % to 10 vol % based on the volume of the solvent of a chemical sintering agent to the colloid, wherein the chemical sintering agent is selected from aqueous solutions of hexafluorotitanic acid, hexafluorozirconic acid, hydrogen fluoride, ammonium fluoride, ammonium bifluoride, and mixtures thereof;
d) optionally pre-treating the electrode;
e) applying the colloid to the optionally pre-treated electrode;
f) heating the coated electrode to a temperature of at most 150° C. for sintering the metal oxide followed by cooling to a temperature ranging from about room temperature to about 120° C.;
g) retrieving the electrode coated with sintered metal oxide.

14. The method of claim 13, wherein the colloid further comprises one or more binders.

15. The method of claim 14, wherein the one or more binders are selected from polyethylene glycol, polyvinyl alcohol, and ethyl cellulose.

16. The method of claim 14, wherein the binder is ethyl cellulose.

17. The method of claim 14, wherein the one or more binder is present in an amount ranging from 20 wt % to 40 wt % based on the weight of the metal oxide.

18. The method of claim 13, further comprising adding a thermal sintering agent to the colloid in an amount up to 20 wt % based on the weight of the metal oxide.

19. The method of claim 18, wherein the thermal sintering agent is incorporated into the metal oxide by sol gel methods or during its synthesis by wet impregnation.

20. The method of claim 18, wherein the thermal sintering agent is a metal oxide different from that used in the colloid.

21. The method of claim 20, wherein the thermal sintering agent is selected from manganese oxide, vanadium oxide, niobium oxide, barium oxide, and cerium oxide.

22. The method of claim 18, wherein the thermal sintering agent is added in an amount of about 10 wt %, based on the weight of the metal oxide.

23. The method of claim 13, wherein the solvent of the colloid is chosen from water and an aqueous titania precursor.

24. The method of claim 23, wherein the solvent is an aqueous titania precursor, and the aqueous titania precursor is present in an amount of about 400 wt % based on the weight of metal oxide.

25. The method of claim 23, wherein the solvent is water, and the water is present in an amount ranging from 300 wt % to 500 wt % based on the weight of the metal oxide.

26. The method of claim 13, wherein the colloid further comprises an adhesion agent.

27. The method of claim 26, wherein the adhesion agent is selected from calcium oxide, calcium hydroxide, polyvinyl alcohol, and a flocculating agent.

28. The method of claim 26, wherein the adhesion agent comprises a flocculating agent selected from polyacrylamide and polyacrylic acid.

29. The method of claim 13, wherein colloid is applied to the electrode by etch deposition, screen printing, or doctor blading the colloid onto the electrode.

30. The method of claim 13, wherein the electrode of step a) is pre-treated with a metal oxide precursor.

31. The method of claim 30, wherein the metal oxide precursor is selected from TiCl₄ and titanium isopropoxide.

32. The method of claim 13, wherein the method comprises pre-treating the electro-conducting substrate of step a) to improve adhesion of the metal oxide film.

33. The method of claim 13, wherein heating the coated electrode to a temperature of at most 150° C. for sintering the metal oxide is followed by cooling to a temperature of about 100° C.

34. The method of claim 13, further comprising post-treating the sintered metal oxide with a metal oxide precursor selected from a solution of TiCl₄ or titanium isopropoxide, and re-sintering to a temperature of at most 150° C., followed by cooling to a temperature ranging from about room temperature to about 120° C.

35. A dye-sensitised solar cell prepared by the method of claim 13.

36. A process for preparing dye sensitised solar cells, including low temperature sintering, comprising the steps of:
a) providing a first electrode;
b) preparing a colloid comprising at least one metal oxide and a solvent, wherein the solvent is present in an amount ranging from more than zero wt % to 500 wt % based on the weight of the metal oxide;
c) adding from more than zero vol % to 10 vol % based on the volume of the solvent of a chemical sintering agent to the colloid, wherein the chemical sintering agent is selected from aqueous solutions of hexafluorotitanic acid, hexafluorozirconic acid, hydrogen fluoride, ammonium fluoride, ammonium bifluoride, and mixtures thereof;
d) optionally pre-treating the first electrode;
e) applying the colloid to the optionally pre-treated first electrode;
f) heating the coated first electrode to a temperature of at most 150° C. for sintering the metal oxide followed by cooling to a temperature ranging from about room temperature to about 120° C.;
g) optionally post-treating the sintered metal oxide with a metal oxide precursor selected from a solution of TiCl₄ or titanium isopropoxide, and re-sintering to a temperature of at most 150° C., followed by cooling to a temperature ranging from about room temperature to about 120° C.;
h) providing a second electrode prepared from a transparent substrate coated with a transparent conducting oxide and additionally coated with platinum or carbon;
i) optionally pre-dyeing the first electrode coated with metal oxide with a solution comprising one or more dyes in order to covalently bind said dye to the surface of the metal oxide;
j) piercing at least two holes in the first and/or second electrodes and sealing said electrodes together with glue or with a thermoplastic polymer;
k) pumping one or more solutions comprising the same one or more dyes as those of the pre-dyeing step along with cosorbents through the holes in the first and/or second electrodes to covalently bind said dye to the surface of the metal oxide, wherein dyeing is carried out between the sealed first and second electrodes at a temperature ranging from 10° C. to 70° C.;
l) injecting an electrolyte through the holes in the first and second electrodes, wherein said electrolyte is added simultaneously with the dye or not more than 10 minutes after dyeing;
m) sealing the holes in the first and second electrodes with glue or with a thermoplastic polymer; and
n) providing an external connection between the first and second electrodes for electron transport.
